(19) United States
(12) Patent Application Publication
(10) Pub. No.: US 2024/0094039 A1
(43) Pub. Date: Mar. 21, 2024

(54) METHOD FOR DETERMINING THE QUANTITY OF A FLUID IN A CONTAINER, AND APPARATUS THEREFOR

(71) Applicant: FRESENIUS MEDICAL CARE DEUTSCHLAND GMBH, Bad Homburg (DE)

(72) Inventors: Felix WEGE, Aachen (DE); Lukas MARIK, Armadni (CZ)

(73) Assignee: FRESENIUS MEDICAL CARE DEUTSCHLAND GMBH, Bad Homburg (DE)

(21) Appl. No.: 18/273,274

(22) PCT Filed: Jan. 28, 2022
(86) PCT No.: PCT/EP2022/052031

§ 371 Date: Jul. 20, 2023

(30) Foreign Application Priority Data
Jan. 28, 2021 (DE) 10 2021 200 761.9

(51) Int. Cl. G01F 23/284; G01S 7/41; G01S 13/00

(52) U.S. Cl. CPC G01F 23/284; G01S 7/412; G01S 7/417; G01S 13/003; G01F 22/00

(57) ABSTRACT

The invention relates to a method for determining the quantity of a fluid in a container (B), having the steps:
transmitting (S20s) a specified bit sequence via an HF signal to determine channel state information, wherein the signal is directed at the container (B) and wherein a quantity to be determined is located in the container (B),
receiving (S20) a reflection or a transmission of the transmitted HF signal,
evaluation of errors and/or error parameters,
comparison of errors and/or error parameters with at least one training parameter.

The invention furthermore relates to a method for determining the quantity of a fluid in a container (B), having the steps:
transmitting (S20s) a first portion of an analog HF signal to determine channel state information, wherein the signal is directed at the container (B) and wherein a quantity to be determined is located in the container (B),
receiving (S20) a reflection or a transmission of the transmitted HF signal,
evaluation of errors and/or error parameters,
comparison of errors and/or error parameters to at least one training parameter.

The invention furthermore relates to a device for carrying out the method.

The invention relates to a method for determining the quantity of a fluid in a container and a device for carrying out such a method.

It is known to measure volumes of a liquid by means of a measuring vessel. However, the transfer of liquids into a measuring vessel is not always practicable. There are liquids, for example, which outgas during the transfer or in the case of which a portion of the material to be measured evaporates. Other liquids can react with ambient gases. For hygienic reasons, other liquids, in turn, are to come into contact with as few other materials as possible.

In the case of a known density, it is likewise known to determine volumes by measuring the weight. During such a measurement, however, the weight of the container, in which the liquid is located, then also has to be known. If this weight is not known in advance, a volume determination can only take place after emptying the liquid or only as differential measurement, respectively. This is often disadvantageous. It is also apparent that weighing devices are comparatively expensive and elaborately constructed.

### OBJECT

Based on this, it is an object of the invention to provide a simple and/or cost-efficient option, by means of which liquids in containers, in particular in flexible containers, can be determined. The measurement is to thereby preferably be made possible in a timely manner, in particular in real time.

### BRIEF DESCRIPTION OF THE INVENTION

The object is solved by means of a method for determining the quantity of a fluid in a container, having the steps:
transmitting a specified bit sequence via an HF signal to determine channel state information, wherein the signal is directed at the container and wherein a quantity to be determined is located in the container,
receiving a reflection or a transmission of the transmitted HF signal,
evaluation of errors and/or error parameters,
comparison of errors and/or error parameters with at least one training parameter.

The object is furthermore solved by means of a method for determining the quantity of a fluid in a container, having the steps:
transmitting a first portion of an analog HF signal to determine channel state information, wherein the signal is directed at the container and wherein a quantity to be determined is located in the container,
receiving a reflection or a transmission of the transmitted HF signal,
evaluation of errors and/or error parameters,
comparison of errors and/or error parameters with at least one training parameter.

The object is furthermore solved by means of a device for carrying out such a method.

Further advantageous designs are subject matter of the respective dependent claims, of the figures, and of the description.

### BRIEF DESCRIPTION OF THE FIGURES

The invention will be described in more detail below with reference to the figures, in which:

FIG. 1 shows a schematic overview of elements in embodiments of the invention,

FIG. 2 shows a schematic arrangement of antennas with regard to the container according to embodiments of the invention,

FIG. 3 shows a schematic arrangement of antennas with regard to the container according to alternative or additional aspects in embodiments of the invention,

FIG. 4 shows a schematic arrangement of antennas with regard to the container according to alternative or additional aspects in embodiments of the invention,

FIG. 5 shows a schematic arrangement of antennas with regard to the container according to alternative or additional aspects in embodiments of the invention,

FIG. 6a-9c shows schematic illustrations of possible embodiments with regard to embodiments of the invention,

FIG. 10 shows a schematic flowchart according to aspects of the invention, and

FIG. 11 shows a further schematic flowchart according to aspects of the invention.

### DETAILED DESCRIPTION OF THE INVENTION

The invention will be described in more detail below with reference to the figures. It should be noted thereby that different aspects are described, which can in each case be used individually or in combination. This means that any aspect can be used with different embodiments of the invention, unless explicitly described as mere alternative.

For the sake of simplicity, reference will furthermore generally always be made below only to one entity. Unless explicitly noted, the invention can, however, in each case also have several of the respective entities. In this respect, the use of the word “one” is to only be understood as reference to the fact that at least one entity is used in a simple embodiment.

Insofar as methods are described below, the individual steps of a method can be arranged and/or combined in any order, unless something different follows explicitly from the context. The methods—unless otherwise expressly identified—can furthermore be combined with one another.

Information with numerical values is generally not to be understood as exact values, but also include a tolerance of from +/−1% to +/−10%.

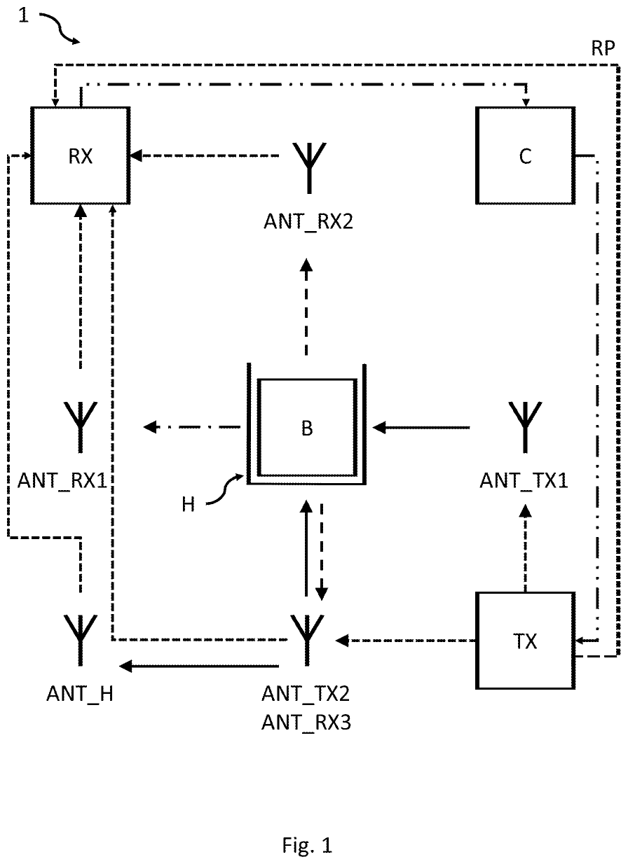

Reference will in particular be made below to FIG. 1, in which a schematic overview of elements is shown in embodiments of the invention. This means that not all described elements are necessary for the solution according to the invention.

In a first embodiment of the invention, a device 1 for measuring volumes of a liquid in a container B by means of measurement of an emitted high-frequency radiation is provided. High-frequency in terms of the invention relates, e.g., to radiation in the ISM bands, radiation in the range of from 1.8 GHz-1.9 GHz, 2.4 GHz-2.5 GHz, 5.1 GHZ-5.8 GHz, and generally speaking, radiation from the frequency range of from approximately 26 MHz to approximately 6 GHz.

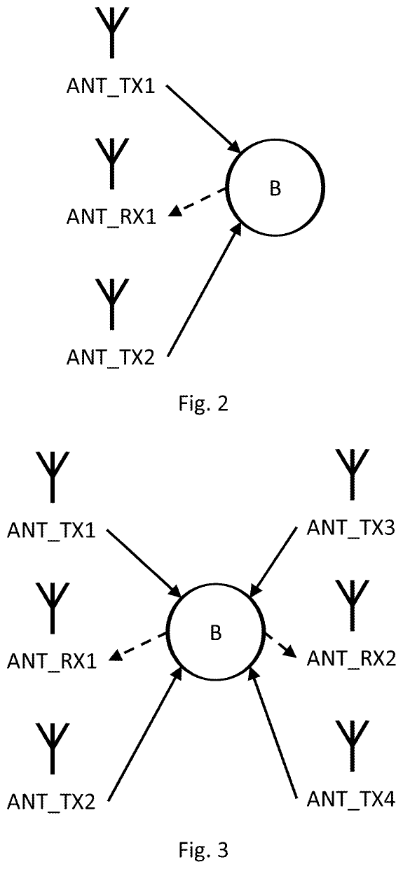

The device 1 has a control unit C, a transmitter TX, at least one first transmitting antenna ANT_TX1, and at least one second transmitting antenna ANT_TX2, at least one first receiving antenna ANT_RX1, and a receiver RX. Such an arrangement is illustrated schematically in FIG. 2.

The transmitter TX is set up to emit high-frequency radiation during operation. The radiation can be modulated on one or several frequencies. The high-frequency radiation carries digital data packets.

The first transmitting antenna ANT_TX1 and the second transmitting antenna ANT_TX2 are set up to emit the high-frequency radiation during operation, so that radiation can get to the container B.

The receiving antenna ANT_RX1, in turn, is set up to absorb high-frequency radiation reflected from the container B during operation.

This means that the device 1 has a predetermined arrangement of transmitting antenna(s), container B, and receiver antenna(s).

The receiver RX is set up to absorb the high-frequency radiation absorbed by the receiving antenna ANT_RX1 during operation.

The control unit C is set up to control the transmitter TX such that the transmitter TX emits high-frequency radiation. This means that the controller prompts the transmitter TX to emit high-frequency radiation in a controlled manner (via one or several antennas) (on one or several frequencies).

The control unit C is further set up to evaluate the high-frequency radiation absorbed by the receiver RX (via one or several antennas) (on one or several frequencies) on the basis of received digital data packets to the effect that a measure for the volume of the liquid in the container B is determined.

The measure for the volume of the liquid in the container B is thereby preferably determined from channel state information.

Channel state information is used in many wireless (digital) communication systems to characterize the properties of a communication channel. The channel state information thus reflects properties along the propagation path, which are influenced, e.g., by scattering, attenuation, drop in performance as a result of distance, etc.

For example, reference points for how transmitting properties should be changed so that a secure connection with preselected properties (such as, e.g., reaching a certain data rate) can be made possible with given channel properties, can be obtained by means of evaluation of channel state information. However, this adaptability with the goal of a secure connection is not relevant in the invention. Only the description of the property of the propagation path is of interest for the invention. Other information, which reflects the properties of the propagation path in a similar way, can be used in the same way in this respect. The invention utilizes the change of channel state information data packets during the propagation of the signal, in particular when passing through liquids: Certain packets show errors after passing through a liquid. The knowledge of the error emergence along the signal propagation is used to determine the liquid volume.

Without loss of generality, the arrangement can be arranged as in FIG. 2 such that the connecting lines between the used transmitting antennas ANT_TX1 and ANT_TX2 form an angle of from 10 to 180°, preferably 300 to 900 with respect to the container B.

In a second embodiment of the invention, a device 1 for measuring volumes of a liquid in a container B by means of measurement of an emitted high-frequency radiation is provided.

The device 1, in turn, has a control unit C, a transmitter TX, at least one first transmitting antenna ANT_TX1, and at least one second transmitting antenna ANT_TX2, at least one first receiving antenna ANT_RX1, and a second receiving antenna ANT_RX2, and a receiver RX. Such an arrangement his illustrated schematically in FIG. 5.

The transmitter TX is set up to emit high-frequency radiation during operation. The radiation can be modulated on one or several frequencies. The high-frequency radiation carries digital data packets.

The first transmitting antenna ANT_TX1 and the second transmitting antenna ANT_TX2 are set up to emit the high-frequency radiation during operation, so that radiation can get to the container B.

The first receiving antenna ANT_RX1 is set up to absorb high-frequency radiation reflected from the container B during operation.

The second receiving antenna ANT_RX2, in contrast, is set up to absorb high-frequency radiation transmitted from the container B during operation.

This means that the device 1 has a predetermined arrangement of transmitting antenna(s), container B, and receiver antenna(s).

The control unit C is set up to control the transmitter such that the transmitter TX emits high-frequency radiation. This means that the controller prompts the transmitter TX to emit high-frequency radiation in a controlled manner (via one or several antennas) (on one or several frequencies).

The control unit C is further set up to evaluate the high-frequency radiation absorbed by the receiver RX on the basis of received digital data packets to the effect that a measure for the volume of the liquid in the container B is determined.

The measure for the volume of the liquid in the container B is thereby preferably determined from channel state information.

Channel state information is used in many wireless communication systems to characterize the properties of a communication channel. The channel state information thus reflects properties along the propagation path, which are influenced, e.g., by scattering, attenuation, drop in performance as a result of distance, etc. The channel state information is to thereby be differentiated from the less informative RSSI (received signal strength indicator).

For example, reference points for how transmission properties should be changed so that a secure connection with preselected properties (such as, e.g., reaching a certain data rate) can be made possible with given channel properties, can be obtained by means of evaluation of channel state information. The invention utilizes the change of channel state information data packets during the propagation of the signal, in particular when passing through liquids: Certain packets show errors after passing through a liquid. The knowledge of the error emergence along the signal propagation is used to determine the liquid volume. However, this adaptability with the goal of a secure connection is not relevant in the invention. Only the description of the property of the propagation path is of interest for the invention. Other information, which reflects the properties of the propagation path in a similar way, can be used in the same way in this respect.

This second embodiment is particularly well suited for the detection of liquids in bags, which tend to change the shape, e.g. by lateral displacement, bulging, etc., during a volume change. Creasing, bulging, displacements, etc. may occur during the change of the volume of a liquid in a flexible bag, which can have a disruptive effect on other measuring arrangements, because this can lead to a shifting of a wall of the container (namely of the bag) relative to measuring systems, such as sensors or antennas.

Even though the devices 1 were described separately above, it can be provided that both embodiments are provided in a common device. A measure for the volume of the liquid in the container B could thus be determined from respective channel state information within a device 1 based on different measuring protocols, both simultaneously or also in a time-delayed manner. Both measures determined in this way can then be provided, e.g., for a plausibility test and/or a notification. It should be noted that with a careful selection, one or several antennas can also serve as transmitting and receiving antenna (e.g. for different spatial measurements in an embodiment, or in a first measurement according to the first embodiment, and in a second measurement according to the second embodiment).

This means that based on a specified structure, the volume in a container B can be measured in a contact-free manner in a particularly simple way in the case of all embodiments.

Without loss of generality of the invention, e.g. conventional hardware, as it can be found, e.g., in the case of WLAN devices, can be used for this purpose. Particularly cost-efficient devices 1 can be provided thereby. For example, receiver RX and transmitter TX and/or the assigned antennas can be components of a WLAN device. It is known that, e.g., certain network chip sets make it possible to determine channel state information or to provide the data, on which this determination is based, respectively. An exemplary chip set is sold as Atheros chip set. Chip sets, which provide this information, can generally also be found in access points, such as, e.g. WLAN-compatible routers and MIMO-compatible devices. A chip set or a WLAN card, respectively, which is compatible with channel state information, is also offered, for example, by Intel.

A corresponding device 1 can thus be realized particularly easily by means of a single computer as control unit C and two network interfaces, which provide for determining a CTI value.

It is optionally provided in embodiments of the invention that the distance between the first transmission antenna ANT_TX1 and the first receiving antenna ANT_RX1 is at least ⅜ of the used wavelength of the high-frequency radiation to be emitted.

It is further optionally provided in embodiments of the invention that the distance between the first transmitting antenna ANT_TX1 and/or of the first receiving antenna ANT_RX1 is at least ⅜ of the used wavelength of the high-frequency radiation to be emitted with respect to the container B.

It is optionally provided in embodiments of the invention that the distance between the first transmission antenna ANT_TX1 and the first receiving antenna ANT_RX1 is approximately 4-times the used wavelength of the high-frequency radiation to be emitted.

It is furthermore provided in embodiments of the invention that the high-frequency radiation, radiation of a near field communication system, or radiation of a frequency, which are authorized for the use for industrial, scientific, medical, domestic, or similar purposes, which are not radio applications, are selected.

Typical near field communication systems are, e.g., WLAN, Bluetooth (low energy), ZigBee, DECT (ultra-low energy) or the successor systems thereof, without thereby being limited to a certain specification. Typical frequencies, which are authorized for the use for industrial, scientific, medical, domestic, or similar purposes, which are not radio applications, can be found in the frequency ranges of 433.05 MHz-434.79 MHz, 902 MHz-928 MHz, 2.4 GHz-2.5 GHz, 5.725 GHz-5.875 GHz, 24 GHz-24.25 GHz, 61 GHz-61.5 GHz, 122 GHz-123 GHz as well as 244 GHz-246 GHz, but without being limited thereto.

In one embodiment of the invention, however, high-frequency radiation with a frequency from the range of 2 GHz to 4 GHz, in particular 2.4 GHz, and in particular signals in the WLAN spectrum and/or according to WLAN specification IEEE 802.11 IEE 802.11b IEEE 802.11g IEEE 802.11n according to the summary in IEE 002-11-2020 is resorted to. In the alternative or in addition, signals in the DECT spectrum, ZigBee, or Bluetooth can also be resorted to, i.e. signals of these transmission technologies can be used.

In a further embodiment of the invention, the container B is a bag. Bags are characterized in that they are generally closed and that the liquid can flow out of the bag/into the bag via a controlled opening. Bags can furthermore change their outer shape, e.g. when liquid is removed from the container B. This means in particular that the outer shape will be able to change under the influence of, e.g., the force of gravity, when a bag B provides a larger volume than a liquid requires in the bag B.

Bags as container B represent a large challenge to the volume determination, but can be managed easily in the context of the invention.

In the case of an embodiment of the invention, at least one transmission antenna ANT_TX1 is mounted on the container B or a receptacle H. For example, an antenna can be imprinted or adhered. The antenna can then be contacted with the transmitter by means of a suitable contact device. A provision of an antenna on the container B or a receptacle H can be advantageous, e.g. when the distance between the transmission antenna and the container B or the liquid, respectively, is to be small or defined, respectively.

In a further embodiment of the invention, at least one receiving antenna ANT_RX1 is mounted on the container B or a receptacle H. For example, an antenna can be imprinted or adhered. The antenna can then be contacted with the transmitter by means of a suitable contact device. A provision of an antenna on the container B or a receptacle H can be advantageous, e.g. when the distance between the receiving antenna and the container B or the liquid, respectively, is to be small or defined, respectively.

The location of the mounting of such a transmission antenna or receiving antenna, respectively, can be selected, i.e., based on properties of the container B, e.g. so that the liquid can be irradiated, e.g., if possible independently of the fill level of the liquid in the container B. For example, a transmission antenna or receiving antenna, respectively, can be arranged on the bottom of the container B.

In one embodiment of the invention, the container B has a flexible wall. It can then be provided that the device 1 for measuring—as outlined in FIG. 1—has a receptacle H comprising a rigid wall, so that in a filled state, the container B abuts laterally against the receptacle H.

For example, the wall can be so high that a bag B, which is fully filled with liquid, when it is located in the receptacle H, does not protrude beyond the wall. For example, the receptacle H can be designed as rigid container, for example as tub or drawer. It can be made, for example, of plastic.

The surface area of the receptacle H can be selected such, e.g., that a bag B, which is fully filled with liquid, can be inserted into the receptacle H. The surface area can thereby be selected such that a bag B, which is fully filled with liquid, touches the wall on approximately 50% of the wall surface of the bag.

It goes without saying that the surface area can also be determined by other considerations. For example, it can thus be desirable that base sizes of the surface area, such as, e.g., the diameter, do not fall below a certain size, e.g. at least one wavelength of the used radiation.

In the case of an embodiment, the receptacle H is designed as one or several mandrels or bars, on which a bag can be suspended. A bag can thereby have eyelets, for example, so that mandrels or bars, respectively, protrude through respective corresponding eyelets during suspension.

In a further embodiment of the invention, the device 1 furthermore has a receiving antenna ANT_H for determining a background radiation. The background radiation can also be determined by means of one or several receiving antennas, which are already present. This is possible, e.g., in times during which the receiving antenna is not required for measurements of a different type.

By means of auxiliary antennas, in particular by means of directional auxiliary antennas (possible both as transmission and as receiving antenna), the portion of the attenuation caused by the free space emission can be determined, e.g. very reliably, wherein a correcting parameter can be determined. If the influence of the free space loss is low, the determination can be forgone.

Without loss of generality of the invention, a transmitting antenna (or several or all) ANT_TX1, ANT_TX2 can have a directional characteristic alternatively to an omnidirectional characteristic.

Without loss of generality of the invention, a receiving antenna (or several or all) ANT_RX1, ANT_RX2, ANT_RX3, ANT_H can have a directional characteristic alternatively to an omnidirectional characteristic.

Omnidirectional characteristic is provided, for example, by a bar antenna. For example, dipolar-like antennas or panel antennas have directional characteristic.

The invention can be used in many fields.

However, the medical field is of particular importance. The medical field includes numerous medical devices M, in the case of which a weight or a volume of a liquid is monitored, e.g. during a treatment.

For example, a medical device M can measure the volume of a liquid in a container B, which is fed to a body of a mammal or which is discharged from a body of a mammal, or which is a liquid in a secondary loop for treatment of this liquid. Exemplary liquids, which are fed to a body of a mammal, are, e.g., infusions, heparin, blood, saline solutions, medicaments for the intravenous administration, parenteral feeding, etc. Exemplary liquids, which are discharged from a body of a mammal, are blood or urine.

The medical device M can in particular be a dialysis device, wherein the liquid is a liquid in connection with a dialysis, in particular dialysate. The dialysis form is not determined thereby, but can relate, e.g., to the kidney dialysis, in particular in the form of the hemodialysis, the peritoneal dialysis, the hemofiltration, hemodiafiltration, and the hemoperfusion, as well as the liver dialysis, in particular the apheresis, single pass albumin dialysis, molecular adsorbents recirculation system.

The medical device M is preferably a dialysis machine, and the dialysis measures the volume of a liquid in one or several bags. In a preferred embodiment, the dialysis machine is connected to a bag B for fresh dialysate and/or for used dialysate. The dialysis machine M can determine the liquid balance during a treatment by measuring fresh and used dialysate. In an advanced embodiment, a dialysis machine M has one or several receptacle(s) H, e.g. for suspending, one or several containers B, e.g., bags—e.g. for dialysate—to the housing thereof, for example to the lower edge, and a device 1 according to the invention for measuring the volume of a liquid in such a way that the dialysis machine M can measure the liquid volume in suspended containers B by means of high-frequency radiation.

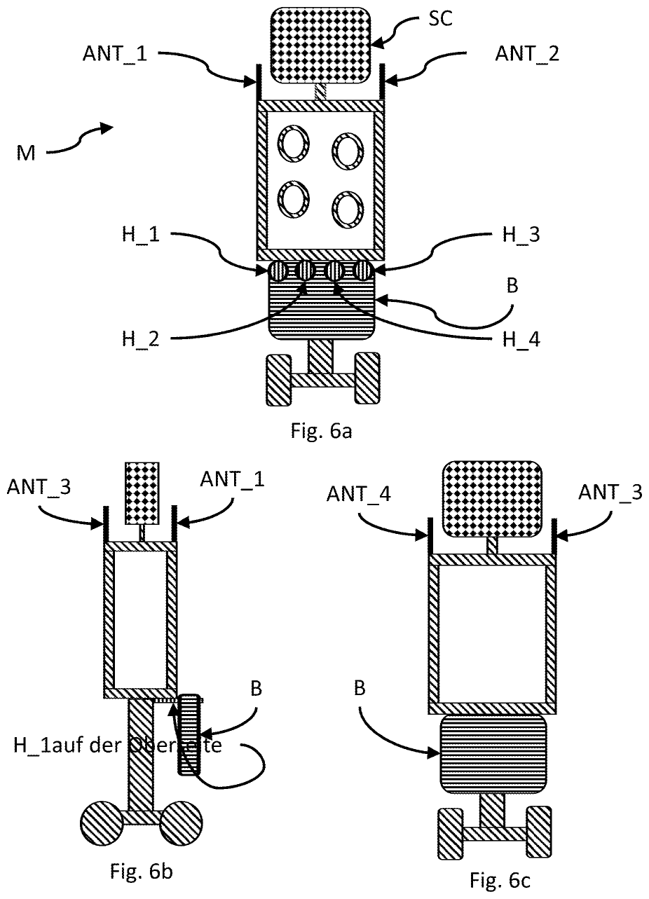

The antennas ANT_1 . . . ANT_5 . . . ANT_N of the device 1 can be suitably arranged thereby. Different attachment points in relation to a medical device M are shown schematically in FIGS. 6 to 9 for this purpose. The medical device M has, e.g., an optical display SC (e.g. a (flat) screen), on which results with regard to one or several volume measurements, e.g. current volume, volume change, volume flow, etc., can be displayed. However, the optional display SC can simultaneously also provide a user interface, by means of which, e.g., a measurement by the device 1 can be prompted manually. Several receptacle(s) H_1, H_2, H_3_ H_4 are shown in the figures. However, only one receptacle H or even more receptacles can also be provided. Instead of one container B, several containers B can likewise also be provided.

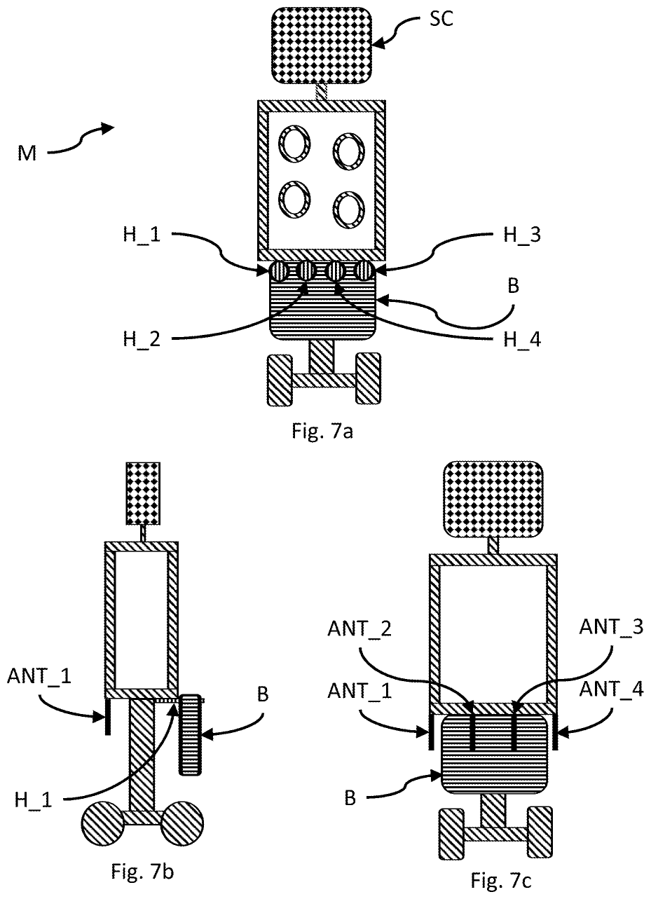

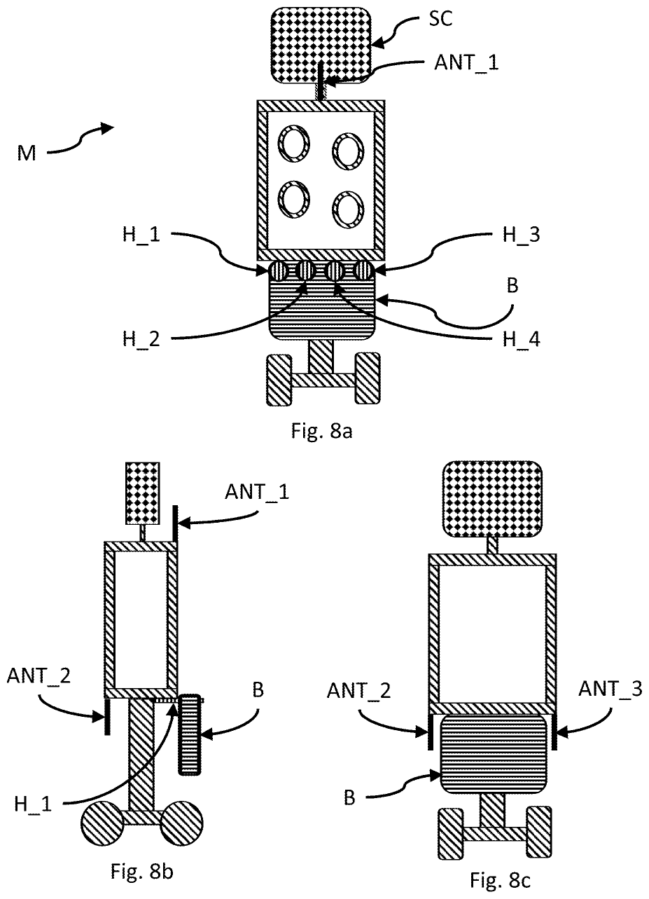

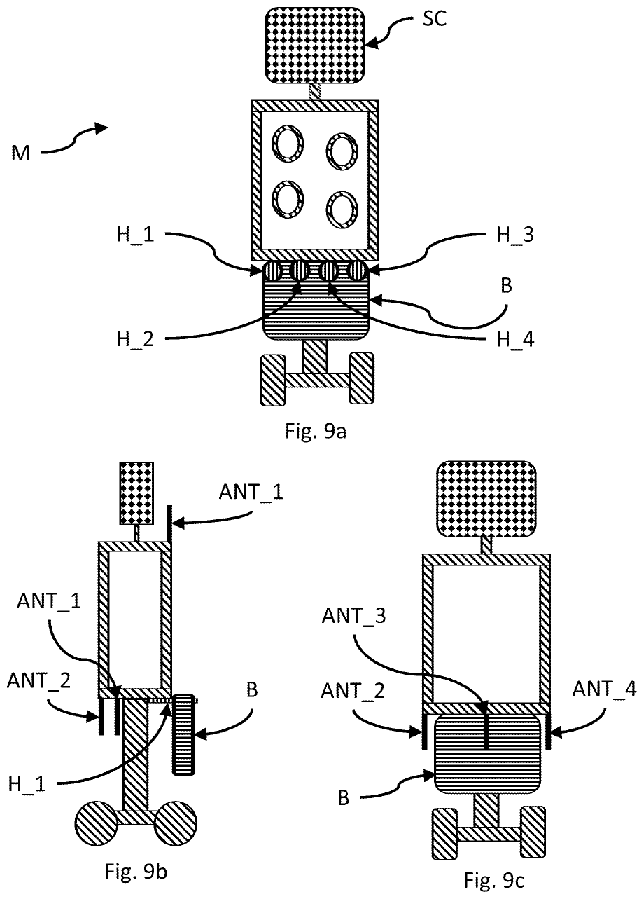

As shown, e.g., in FIG. 6a-6c, the antennas ANT_1 . . . ANT_4 . . . ANT_N of the device 1 can be arranged on the top side of the medical device M. However, as shown in FIG. 7a-7c, the antennas can also be arranged on the bottom side of the medical device M. However, other arrangements are also not ruled out thereby. For example as shown in FIG. 8a-8c, the antennas can also be arranged so as to be distributed. While ANT_1 is arranged more centrally on the front side, the antennas ANT_2 and ANT_3 can be arranged, e.g., so as to be distributed on the bottom side. In FIG. 9a-9c, antenna ANT_1, e.g., is arranged so as to be offset to the antennas ANT_2 . . . ANT_4.

The function of the antennas ANT_1 . . . ANT_5 . . . ANT_N of the device 1, i.e. as transmitting antenna and/or as receiving antenna can be suitably selected.

For example, expensive and complex scales can be saved thereby, and, on the other hand, this has the advantage that heavy bags B only have to be suspended on the bottom of the housing of the medical device M, and do not have to be placed for instance onto the top of a weighing pan. The handling is facilitated thereby. Such medical devices M can be used in regions with unsteady water supply, in temporary or mobile uses, or in intensive care units.

The medical device of FIGS. 6-9 can be, for example, a dialysis treatment machine (in particular hemodialysis machine) comprising a device 1 according to the invention. For example, the fill level in a connected container B is measured (and monitored) in the case of such dialysis treatment machines. The container B is typically a 5 L plastic canister. A typical liquid, which is stored in such a container B, is a concentrate for the dialysis treatment. For example, the liquids contain acetates or bicarbonates.

It can be attained in a particularly advantageous manner thereby that the container B/the containers B cannot be emptied unexpectedly during a treatment, and that the desired treatment parameters cannot be adhered to, or that a pump draws in air, etc.

It can be provided in all embodiments that the measure for the volume of the liquid in the container B is determined via a plurality of individual measurements, e.g. several 10 thousands of measurements, for example 27 thousand measurements. For example, a plurality of data packets can be transmitted and received thereby. The associated parameters, such as, e.g., the channel state information, can thereby represent an average value themselves, or can optionally be averaged themselves.

In addition, it can be provided in all embodiments that the measuring arrangements of transmitting antenna(s) and receiving antenna(s) are present multiple times.

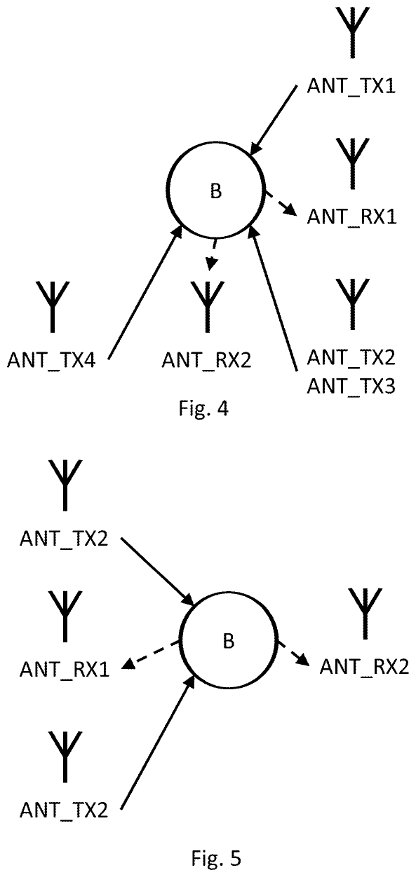

If, e.g., an arrangement according to FIG. 2 is provided multiple times, it can be provided, e.g., that the arrangements have an angle of from 15° to 135° to one another, as shown in FIG. 4.

In FIG. 3, e.g., a first arrangement could consist of the transmitting antennas ANT_TX1, ANT_TX2 and of the receiving antenna ANT_RX1, while, shown in a mirror-inverted manner thereto, a second arrangement consists of the transmitting antennas ANT_TX3, ANT_TX4 and of the receiving antenna ANT_RX2.

In general, the arrangements can have different positions to one another and/or the arrangements can be set up differently from one another.

In a method according to the invention for determining the quantity of a fluid in a container B, which can be used in one of the above-mentioned devices, a specified bit sequence is transmitted in a first step S20s via a HF signal from a transmitter TX to a receiver RX. The receiver can thereby determine channel state information. The HF signal is thereby directed at the container B, and a quantity to be determined is located in the container B.

In a step S20, the receiver RX receives a reflection or a transmission of the transmitted HF signal.

In one or several subsequent steps, one or several errors and/or error parameters is/are now evaluated.

The errors and/or error parameters obtained in this way can subsequently be compared to one or several training parameters and can thus be evaluated in step S600.

This method is suitable in particular for digital measuring values. It can in particular be used to compare a bit error rate with respect to one (or several) bit sequence(s) to a bit error rate from a training sequence. The measure for the bit error rate can thereby be derived, e.g., from a channel quality indicator.

The known bit sequence can in particular be a training sequence. If, e.g., a ping-like implementation is used on the application layer (in the ISO/OSI layer model), this can be displayed in a particularly simple manner.

In embodiments of the invention, the training parameters can in particular also be determined beforehand. For this purpose, the method has the transmitting S20s of the specified bit sequence via an HF signal for determining channel state information, wherein the signal is directed at the container B, and wherein a known quantity is located in the container B. A reflection or a transmission of the transmitted HF signal is thereby received in a step S20s, and at least one training parameter for the comparison of errors and/or error parameters can subsequently be determined in step S500.

Such a training parameter determination can obviously be performed at each individual device, e.g. can be “calibrated” with known fill levels, or training parameters of a reference device can be stored in the respective devices. They can then be stored, e.g., in the form of a look-up table and can be renewed or supplemented, if necessary. For this purpose, corresponding data can be made available, e.g. on the container B, (e.g. QR encoded, or readable via an RFID chip, or accessible via a link/a software update).

This can be advantageous, e.g., when the shape and/or the material of the container B and/or the liquid in a container B changes.

However, a method can also be specified in the same way for analog measuring values. A first portion of an analog HF signal for determining channel state information is in turn transmitted thereby in a step S20s, wherein the signal is directed at the container (B), and wherein a quantity to be determined is located in the container (B). A reflection or a transmission of the transmitted HF signal is likewise received in step S20s. As before, errors and/or error parameters are subsequently evaluated in order to compare them to at least one training parameter in step S600.

In the same way the training parameters can also be determined as before in this analogous case in embodiments of the invention. For this purpose, the method has the transmitting S20s of the first portion of an analog HF signal for determining channel state information, wherein the signal is directed at the container B, and wherein a known quantity is located in the container B. A reflection or a transmission of the transmitted HF signal is thereby received, in turn, in step S20s, and at least one training parameter for the comparison of errors and/or error parameters is subsequently determined in step S500.

Such a training parameter determination can obviously be performed at each individual device, e.g. can be “calibrated” with known fill levels, or training parameters of a reference device can be stored in the respective devices. They can then be stored, e.g., in the form of a look-up table and can be renewed or supplemented, if necessary. For this purpose, corresponding data can be made available, e.g. on the container B, (e.g. QR encoded, or readable via an RFID chip, or accessible via a link/a software update).

This can be advantageous, e.g., when the shape and/or the material of the container B and/or the liquid in a container B changes.

Individual values as well as a plurality of values can be processed in the respective steps. A plurality of values can thereby be combined initially and a comparison with training parameters can then be carried out from the combined values, or a comparison with training parameters is carried out in each case for the individual values, and the respective comparisons are combined.

Mixed forms can obviously also be provided.

For example, a certain number (e.g. 100) of similar parameters can be recorded and processed, e.g., determined in a predetermined time period (e.g. 1 second). If a predetermined number (e.g. 95 or 95%, respectively) leads to the same/similar result/classification, the evaluation can be assumed to be reliable. A moving window can thereby also be used. This means that older results/classifications are not included in the window, as soon as new results/classifications are processed. In this respect, a window provides a combination of a plurality of values. If the required identity/similarity then appears, the result/classification can then be assumed to be reliable. It can be assumed, for example, that the values are similar when they move, e.g. within a range of +/−5% of the (moving) average value.

Parameter can thereby be, e.g., the CSI value (complex, scalar, etc.) or also a bit sequence, in particular a (wireless) data packet. The data packet can in particular also describe only the payload data and/or individual or several header data of a data packet in a transmission frame.

For example, it was possible to determine 2800 packets per second in a test setup in the 2.4 GHz range (WLAN). In a setup of this type, an evaluation of sequences of 100-10000 packets would permit a real time processing without any problems and would be quick enough for real time measurements. In one test setup, approximately 100 packets/second were transmitted, e.g., via a 3×3 MIMO transmission system comprising 30 carriers. This means that it was possible to thereby capture and evaluate 54000 values per second from the corresponding CSI data (amplitude and phase or complex value or quadrature and in-phase components).

The statistics for the parameters within a predetermined time period can thus be improved. It may even be the case that 100 and more packets per second have to be processed, in order to reach a meaningful measurement, because individual measuring values can be faulty due to interferences, so that with an increasing number, the statistical probability makes the interferences more improbable. It can also play a role thereby that, e.g. a moving filter is used, because it is to be assumed in the case of the containers that they will either empty or fill, so that maximum inflow or outflow rates, respectively, are to be expected on the basis of a value for the normal operation, which had been recognized beforehand as being correct, so that the old values can serve as basis for the expectation horizon during new measurements in the near future, and can thus represent a plausibility boundary.

In particular in the medical field, the use of established or already used wireless transmission media lends itself for the provision of HF signals. In particular the use of near field communication systems, such as, e.g. WLAN or Bluetooth, which are already being used at this point for communication purposes in the medical field and also for the communication with medical equipment, lends itself, because they already meet the regulatory requirements for interference resistance of the medical device, and expensive approval thus does not become necessary.

Without loss of generality, it can even be provided that parasitic radiation is used. For example, a medical device, which already has corresponding high-frequency systems for communication purposes, can receive radiation, which is used for communication purposes, in a “parasitic manner” by means of an antenna, in the case of which the radiation was transmitted through the container, and/or the high-frequency systems can provide corresponding HF signals for measuring purposes—as already described above—in non-communication phases. It can obviously also be provided, however, that, e.g. a certain number of HF signals are scattered into the communication on a regular/non-regular basis, if necessary. It can also be provided that a beam forming is activated or deactivated selectively for the measurements.

According to an optional aspect of the present technical solution, a medical treatment device has, for example, a WLAN communication system, which is intended for the general data communication of the device. The electromagnetic radiation during normal operation was considered to be acceptable for the intended purpose, and the entire device is approved. For example, a configuration of antennas and transmission/reception capabilities (e.g. CSI) and sufficient evaluation capabilities, which is suitable for carrying out the present technical solution, can thereby likewise. In addition to its general communication purpose, the communication could additionally be used in this exemplary case for the quantity determination of a fluid according to the present technical solution. Particularly advantageously, costs are not incurred here, because one system can fulfill two tasks. Depending on the communication requirements, communication and quantity determination can take place simultaneously or alternately.

In embodiments of the invention, it can in particular be provided that the transmission S20s of a second portion of the (analog) HF signal for determining channel state information is made possible via a known channel RP at a reference receiver RX. The known channel RP can thereby be a wire-connected interface, wherein a portion of the HF signal is guided through a signal splitter prior to the emission by means of an antenna, wherein the second portion is guided directly to the reference receiver RX. The second portion can also be the object of a weakening via an attenuator, in order to return the signal, which can be expected at the receiver, to corresponding signal levels. In the alternative, it can also be provided that the emitted HF signal is emitted by an antenna such that a portion is radiated (directly) onto an antenna for the reference receiver RX, while another portion is directed at the container B. The portion emitted on the antenna for the reference receiver RX can be provided, e.g. by means of an auxiliary radiation lobe of an antenna, while the main radiation lobe is directed at the container B.

A reference signal can be provided with this design. This is advantageous in particular when the evaluation of phase information is desired or required. This means that the invention can thus also be used in the cases, in which an unknown phase rotation could occur otherwise.

It goes without saying that this case can also be represented in the respective training parameters. This means that in embodiments of the invention, the method can also have the transmission in step S20s of a second portion of the (analog) HF signal for determining channel state information via a known channel RP to a reference receiver RX for determining a phase training parameter, and the transmission S20s of a second portion of the analog HF signal for determining channel state information via a known channel to a reference receiver RX for comparing errors and/or error parameters to at least the phase training parameter.

In all embodiments, the steps can in particular be run through several times, wherein a comparison of errors and/or error parameters to at least one training parameter is only carried out when a predeterminable confidence criterion is met.

This is advantageous in particular for a training in terms of a machine learning.

The confidence criterion can in particular be met, when either a predetermined number of similar errors and/or error parameters was determined, and/or a predetermined number of errors and/or error parameters were pre-classified.

Without loss of generality, an error parameter and/or a training parameter can be classified prior to an evaluation or determination, respectively.

An error parameter and/or a training parameter can furthermore be determined on the basis of a plurality of essentially consecutive values.

An error parameter and/or a training parameter can likewise be classified prior to an evaluation or determination, respectively, by means of a random forest method.

Random forest is preferred thereby. Other methods, such as deep neural nets, boosted tree, linear regression, which provide for a continuous regression of the fill levels to be determined, or supported vector machines, in particular as classification algorithm for discrete fill levels, which are known beforehand, are not ruled out thereby.

Random forest can in particular be implemented easily in phyton. The practical implementation, e.g. compared to deep neural, is in particular simpler and requires less computing effort.

A linear regression can be advantageous when the container B deforms uniformly. However, if the containers B tend to wrinkle, e.g., the linear regression can reach its limits.

Unlike in the case of supported vector machines, only little memory is required. In addition, supported vector machines require complex adaptations.

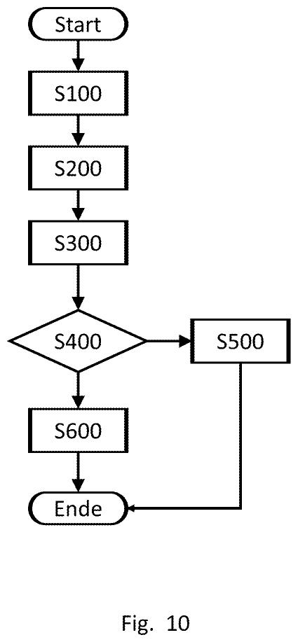

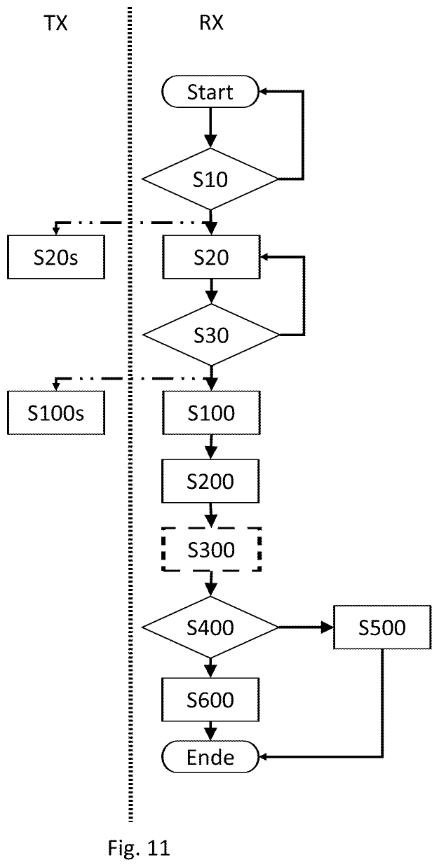

For example, the step S100 can stand for reading analog/digital values, e.g. a CSI value in FIGS. 10 and 11. Such values can be read directly, e.g. from some chip sets. A ping command, e.g., which leads to a periodic signal emission, can be used as signal.

This value, which is present, e.g. in a machine-readable format, can be transferred into an optional other format, e.g. a decimal format, in a step S200. This can take place, e.g. by means of corresponding matlab or C routines.

In an optional step S300, a filtering or pre-processing, respectively, can take place. Such values, which deviate by a certain confidence interval around the average value, can be ruled out, for example, in the case of a plurality of values, which are captured within a short time. Possible measuring errors, e.g. due to interferences, can thus be filtered out. On the other hand, however, it is also possible to perform phase adaptations and/or normalizations.

In step S400, a decision can then be made about a classification or about a training. If the value is required for a training, it can be fed to the training procedure in step S500. Otherwise, the value can be fed to the determination in step S600.

This method is slightly expanded in FIG. 11, because it provides for a triggering.

It is verified in step S10 if a trigger is present. If no trigger is present, the method returns so frequently, until a trigger is present.

If a trigger is present, the transmission (on the part of the transmitter TX) or/receiving (on the part of the receiver RX), respectively, is triggered in step S20.

It is verified in step S30, if an HF signal or a bit sequence, respectively, is present. If this is not the case, the method returns so frequently, until an HF signal or a bit sequence, respectively, is present.

The triggered embodiment has a reduction of interferences, as they could appear, e.g., during the spatially near use of similar devices. In addition, a measurement can be controlled, e.g., by means of other devices/alarm conditions/users (both activation and deactivation). With a triggered embodiment (also triggered in a time-controlled manner), the energy consumption as well as possible interferences of other devices can likewise be minimized. It is advantageous thereby that the quantity of a liquid to be determined generally only changes slowly, so that, e.g., a triggering every 5-60 seconds can be completely sufficient.

As an example, concrete embodiments will be described below on the basis of FIGS. 10 and 11.

For example, the step S100 in FIG. 10 can stand for the reading of CSI values (complex or amplitude and phase, scalar). Such values can be read directly, e.g., from some chip sets. A ping command, e.g., which leads to a periodic signal emission, can be used as signal.

This CSI value, which is present, e.g., in a machine-readable format, can be transferred into another format, e.g. a (decimal) format, which can be processed/read better, in a step S200. This can take place, e.g., by means of corresponding matlab or C routines.

In an optional step S300, a filtering or pre-processing, respectively, can take place. For example, phase adaptations and/or normalizations can be performed.

In step S400, a decision can then be made about a classification or about a training. If the value is required for a training, it can be fed to the training procedure in step S500. Otherwise, the value can be fed to the determination in step S600. The determination is then based on previously obtained training procedures.

In FIG. 11, it can be verified after the start in step S10 if a trigger is present. If no trigger is present, the method returns so frequently, until a trigger is present.

If a trigger is present, the transmission is triggered in step S20s (on the part of the transmitter TX) or/receiving (on the part of the receiver RX), is triggered in step S20 respectively.

It is verified in step S30, if an HF signal or a bit sequence, respectively, is present. If this is not the case, the method returns so frequently, until an HF signal or a bit sequence, respectively, is present.

If, in contrast, an HF signal or a bit sequence, respectively, are present, one can proceed as described above with regard to FIG. 10.

According to the invention, a device for performing one of the above-described methods, is in particular a medical device M, having a receptacle or a connecting element for a container B, further having at least one control unit C, a transmitter TX, at least one first transmitting antenna ANT_TX1, and at least one second transmitting antenna ANT_TX2, at least one first receiving antenna ANT_RX1, and a receiver RX, wherein the control device C is (programmatically) set up to carry out a method according to the preceding description.

1. A method for determining the quantity of a fluid in a container, having the steps:
transmitting a specified bit sequence via an HF signal to determine channel state information, wherein the signal is directed at the container and wherein a quantity to be determined is located in the container,
receiving a reflection or a transmission of the transmitted HF signal,
evaluation of errors and/or error parameters,
comparison of errors and/or error parameters with at least one training parameter.

2. The method according to claim 1, wherein the training parameters are determined beforehand, wherein the method has the steps of:
transmitting the specified bit sequence via an HF signal to determine channel state information, wherein the signal is directed at the container and wherein a known quantity is located in the container,
receiving a reflection or a transmission of the transmitted HF signal,
determination of at least one training parameter for the comparison of errors and/or error parameters.

3. A method for determining the quantity of a fluid in a container, having the steps:
transmitting a first portion of an analog HF signal to determine channel state information, wherein the signal is directed at the container and wherein a quantity to be determined is located in the container,
receiving a reflection or a transmission of the transmitted HF signal,
evaluation of errors and/or error parameters,
comparison of errors and/or error parameters to at least one training parameter.

4. The method according to claim 3, wherein the training parameters are determined beforehand, wherein the method has the steps of:
transmitting the first portion of an analog HF signal for determining channel state information, wherein the signal is directed at the container, and wherein a known quantity is located in the container,
receiving a reflection or a transmission of the transmitted HF signal,
determination of at least one training parameter for the comparison of errors and/or error parameters.

5. The method according to claim 3, having the step:
transmitting a second portion of the analog HF signal for determining channel state information via a known channel to a reference receiver.

6. The method according to claim 4, having the steps:
transmitting a second portion of the analog HF signal for determining channel state information via a known channel to a reference receiver for determining a phase training parameter,
transmitting a second portion of the analog HF signal for determining channel state information via a known channel to a reference receiver for comparing errors and/or error parameters to at least the phase training parameter.

7. The method according to claim 1, wherein the steps are run through several times, wherein a comparison of errors and/or error parameters to at least one training parameter is only carried out when a predeterminable confidence criterion is met.

8. The method according to claim 7, wherein the confidence criterion is met, when either
a predetermined number of similar errors and/or error parameters was determined, or
a predetermined number of errors and/or error parameters were pre-classified.

9. The method according to claim 8, wherein the predetermined number is at least 100 per second.

10. The method according to claim 8, wherein the predetermined number is maximally 100000 per second.

11. The method according to claim 1, wherein an error parameter and/or a training parameter is classified prior to an evaluation or determination, respectively.

12. The method according to claim 1, wherein an error parameter and/or a training parameter is determined on the basis of a plurality of essentially consecutive values.

13. The method according to claim 1, wherein an error parameter and/or training parameter is classified prior to an evaluation or determination, respectively, by means of a random forest method.

14. The method according to claim 1, wherein the HF signal has a frequency of at least 26 MHz and/or of maximally 6 GHz.

15. A device for carrying out a method for determining the quantity of a fluid in a container, said device comprising a receptacle or a connecting element for a container, further having at least one control unit, a transmitter, at least one first transmitting antenna, and at least one second transmitting antenna, at least one first receiving antenna, and a receiver, wherein the control device is set up to carry out the method according to claim 1.

16. A device for carrying out a method for determining the quantity of a fluid in a container, said device comprising a receptacle or a connecting element for a container, further having at least one control unit, a transmitter, at least one first transmitting antenna, and at least one second transmitting antenna, at least one first receiving antenna, and a receiver, wherein the control device is set up to carry out the method according to claim 3.

17. The device of claim 15, wherein the device is a medical device.

18. The device of claim 16, wherein the device is a medical device.

19. The method according to claim 3, wherein an error parameter and/or a training parameter is determined on the basis of a plurality of essentially consecutive values.

20. The method according to claim 3, wherein an error parameter and/or training parameter is classified prior to an evaluation or determination, respectively, by means of a random forest method.
